(19) United States
(12) Patent Application Publication
(10) Pub. No.: US 2025/0071036 A1
(43) Pub. Date: Feb. 27, 2025

(54) IN-VEHICLE DEVICE, PROGRAM, AND INFORMATION PROCESSING METHOD

(71) Applicants: NATIONAL UNIVERSITY CORPORATION TOKAI NATIONAL HIGHER EDUCATION AND RESEARCH SYSTEM, Nagoya-Shi, Aichi (JP); AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventors: Ryo Kurachi, Nagoya-shi, Aichi (JP); Hiroaki Takada, Nagoya-shi, Aichi (JP); Hiroshi Ueda, Yokkaichi-shi, Mie (JP)

(73) Assignees: NATIONAL UNIVERSITY CORPORATION TOKAI NATIONAL, Nagoya-Shi, Aichi, (JP); AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/723,355

(22) PCT Filed: Dec. 13, 2022
(86) PCT No.: PCT/JP2022/045756

§ 371 Date: Jun. 21, 2024

(30) Foreign Application Priority Data
Dec. 27, 2021 (JP) 2021-212667

(51) Int. Cl. H04L 43/0823; H04L 43/06; H04L 67/2871

(52) U.S. Cl. CPC H04L 43/0847; H04L 43/06; H04L 67/2871

(57) ABSTRACT

An in-vehicle device is an in-vehicle device connected to an in-vehicle ECU mounted on a vehicle such that communication is available, and includes a control unit performing processing relevant to transmission data transmitted from the in-vehicle ECU, in which the control unit receives transmission data transmitted from the in-vehicle ECU, registers the received transmission data in association with a reception time point of the transmission data in a chronological database, specifies abnormal transmission data from the transmission data registered in the chronological database, and registers information relevant to the specified abnormal transmission data in an abnormality history database.

### CROSS-REFERENCE TO RELATED APPLICATION

This application claims priority based on PCT Application PCT/JP2022/045756 filed on Dec. 13, 2022 which claims priority to Japanese Application No. 2021-212667 filed on Dec. 27, 2021, and incorporates all the contents described in Japanese Application described above.

### TECHNICAL FIELD

The present disclosure relates to an in-vehicle device, a program, and an information processing method.

### BACKGROUND

In the related art, a communication protocol of a controller area network (CAN) is widely adopted in a communication protocol used for communication between a plurality of devices such as an electronic control unit (ECU) mounted on a vehicle.

In Japanese Patent Laid-Open Publication No. 2009-220800, a detection/control integration device that is connected to CAN of a vehicle, allows an in-vehicle device to execute an operation in accordance with a device diagnosis command, imports state response data transmitted from the in-vehicle device, and determines an operation state of the in-vehicle device is proposed.

In the detection/control integration device of Japanese Patent Laid-Open Publication No. 2009-220800, there is a problem that the storage, the management, and the like of data such as a controller area network (CAN) message transmitted from an in-vehicle electronic control unit (ECU) in association with a temporal element such as a reception time point of the data is not considered.

An object of the present disclosure is to provide an in-vehicle device and the like capable of storing data transmitted from an in-vehicle ECU in association with a temporal element such as a reception time point of the data to efficiently perform processing relevant to the data transmitted from an in-vehicle ECU by using the data associated with the temporal element.

### SUMMARY

An in-vehicle device according to one aspect of the present disclosure is an in-vehicle device connected to an in-vehicle ECU mounted on a vehicle such that communication is available, and includes a control unit performing processing relevant to transmission data transmitted from the in-vehicle ECU, in which the control unit receives the transmission data transmitted from the in-vehicle ECU, registers the received transmission data in association with a reception time point of the transmission data in a chronological database, specifies abnormal transmission data from the transmission data registered in the chronological database, and registers information relevant to the specified abnormal transmission data in an abnormality history database.

### Effects of Present Disclosure

According to one aspect of the present disclosure, it is possible to provide the in-vehicle device and the like storing the data transmitted from the in-vehicle ECU in association with the temporal element such as the reception time point of the data to efficiently perform the processing relevant to the data transmitted from the in-vehicle ECU by using the data associated with the temporal element.

### BRIEF DESCRIPTION OF THE DRAWINGS

FIG. 1 is a schematic view illustrating a configuration of an in-vehicle system including an in-vehicle device according to Embodiment 1.

FIG. 2 is a block diagram illustrating a physical configuration of the in-vehicle device.

FIG. 3 is an explanatory diagram (an ER diagram) illustrating various databases stored in a storage unit of the in-vehicle device.

FIG. 4 is an explanatory diagram illustrating a chronological database (a CAN message table).

FIG. 5 is an explanatory diagram illustrating a chronological database (an IP packet table).

FIG. 6 is an explanatory diagram illustrating an abnormality history database.

FIG. 7 is an explanatory diagram illustrating an attack detection database.

FIG. 8 is a functional block diagram illustrating a function unit included in a control unit of the in-vehicle device.

FIG. 9 is an explanatory diagram illustrating an attack detection mode.

FIG. 10 is a flowchart illustrating processing of the control unit of the in-vehicle device.

### DETAILED DESCRIPTION OF PREFERRED EMBODIMENTS

First, an embodiment of the present disclosure will be described. In addition, at least some of the following embodiment may be arbitrarily combined.

(1) An in-vehicle device according to one aspect of the present disclosure is an in-vehicle device connected to an in-vehicle ECU mounted on a vehicle such that communication is available, and includes a control unit performing processing relevant to transmission data transmitted from the in-vehicle ECU, in which the control unit receives the transmission data transmitted from the in-vehicle ECU, registers the received transmission data in association with a reception time point of the transmission data in a chronological database, specifies abnormal transmission data from the transmission data registered in the chronological database, and registers information relevant to the specified abnormal transmission data in an abnormality history database.

In this aspect, the control unit of the in-vehicle device registers the transmission data from the in-vehicle ECU in association with the reception time point of the transmission data in the chronological database stored in an accessible storage area of the processing, such as a storage unit or the like of the in-vehicle device. Accordingly, it is possible to chronologically register each of a plurality of transmission data pieces received by the in-vehicle device in association with a temporal element such as the reception time point in the chronological database of the in-vehicle device, and perform search processing, analysis processing, and the like from various viewpoints with respect to the plurality of transmission data pieces associated with the temporal element. The control unit of the in-vehicle device registers the information relevant to the abnormal transmission data (abnormality information) specified from the transmission data registered in the chronological database in the abnormality history database, as a part of the search processing, the analysis processing, and the like. Accordingly, it is possible to perform the search and analysis processing or the like various viewpoints with respect to the abnormality information registered in the abnormality history database. By separating the chronological database for conserving and managing the received transmission data from the abnormality history database for conserving and managing the abnormal transmission data in the received transmission data, it is possible to perform normalization between the databases, and optimize each of the databases in accordance with attribute.

(2) In the in-vehicle device according to one aspect of the present disclosure, the control unit determines whether the transmission data received from the in-vehicle ECU is normal, registers the transmission data determined as normal in the chronological database, and registers the transmission data determined as abnormal in the abnormality history database.

In this aspect, each time when the transmission data is received (acquired) from the in-vehicle ECU, the control unit of the in-vehicle device determines whether the transmission data is normal, registers the normal transmission data in the chronological database, and registers the abnormal transmission data in the abnormality history database. As described above, right or wrong determination that can be performed on the basis of single transmission data is executed as preprocessing for registration in the database, and the registration in either the chronological database or the abnormality history database can be performed in accordance with the result of the right or wrong determination. Accordingly, it is possible to reduce a data amount redundantly registered in both of the chronological database and the abnormality history database, and prevent the amount of space in the storage unit storing the database from being tightened.

(3) In the in-vehicle device according to one aspect of the present disclosure, when the transmission data received from the in-vehicle ECU is included in a normal data list set in advance, the control unit determines that the transmission data is normal.

In this aspect, the normal data list in which information indicating the normal transmission data is listed is stored in the storage unit of the in-vehicle device, and in a case where the received transmission data is included in the normal data list, the control unit of the in-vehicle device determines that the transmission data is normal with reference to the normal data list. In CAN, the information listed in the normal data list (the information indicating the normal transmission data), for example, is CAN-ID (a message ID), a range of a value included in a payload, and the like. In TCP/IP, the information, for example, includes a port number, an address of a transmission source, a transmission destination address, or the like, and the normal data list in which such information is listed corresponds to a white list for specifying the normal transmission data. It is possible for the control unit of the in-vehicle device to efficiently determine whether the received transmission data is normal with reference to the normal data list (the white list).

(4) In the in-vehicle device according to one aspect of the present disclosure, when an error is detected in at least one of an authorization code, an inspection code, and a form included in the transmission data received from the in-vehicle ECU, the control unit determines that the transmission data is abnormal.

In this aspect, the control unit of the in-vehicle device determines whether the transmission data is abnormal, and thus, is capable of efficiently performing the right or wrong determination on the basis of a detection result of the error with respect to the authorization code such as a message authentication code (MAC), the inspection code such as a cyclic redundancy check (CRC), or the form (the insertion of a rogue bit to a field with a fixed bit number).

(5) In the in-vehicle device according to one aspect of the present disclosure, the control unit extracts a plurality of transmission data pieces by using a predetermined search formula for the chronological database, and specifies the abnormal transmission data on the basis of an extraction result of the plurality of transmission data pieces.

In this aspect, in the storage unit of the in-vehicle device, the search formula used for the chronological database (a search formula for the chronological database), for example, is stored as a query definition file defined by using a query description language such as a structured query language (SQL). The control unit of the in-vehicle device issues a processing command with respect to the chronological database using the search formula (a query) described in the query definition file with reference to the query definition file, and thus, is capable of efficiently extracting (searching) the plurality of transmission data pieces required to specify the abnormal transmission data. By using the query definition file with respect to the chronological database, it is possible to store and apply the query definition file separately from an execution file (an exe file) that is a control program itself executed by the control unit of the in-vehicle device, and the query definition file is called out from the execution file. Accordingly, by changing or updating the query definition file without performing update processing (reprogramming) of the execution file itself, it is possible to make the search processing with respect to the chronological database variable, and improve availability in the chronological database. The number of query definition files for a chronological database stored in the storage unit of the in-vehicle device is not limited to one, and a plurality of query definition files may be stored. In the plurality of query definition files, for example, different search formulae (queries) corresponding to the state of the vehicle (a driving state, a stopping state, a pausing state, and the like) are defined (described), and the control unit of the in-vehicle device selects any query definition file in accordance with the state of the vehicle. Then, the control unit of the in-vehicle device may specify (extract) the abnormal transmission data from the chronological database by using the selected query definition file. As described above, it is possible to secure the flexibility of the processing with respect to the chronological database by using the query definition file for the chronological database, and efficiently specify (extract) the abnormal transmission data by using the chronological database.

(6) In the in-vehicle device according to one aspect of the present disclosure, the control unit cyclically performs extraction processing of the transmission data using a search formula for the chronological database, and the cycle (a cycle of cyclically extraction processing) is longer than a reception frequency of the transmission data transmitted from the in-vehicle ECU.

In this aspect, the control unit of the in-vehicle device cyclically performs the extraction processing of the transmission data using the search formula for the chronological database, and thus, is capable of cyclically performing the registration in the abnormality history database, in accordance with the extraction result of the cyclically performed extraction processing. Accordingly, it is possible to secure the freshness of the data registered in the abnormality history database. Since the cycle of the extraction processing is set to a period longer than the reception frequency of the transmission data, it is possible to perform processing with respect to the plurality of transmission data pieces received in the period of one cycle, and suppress an increase in a processing load of the control unit due to excessive extraction processing.

(7) In the in-vehicle device according to one aspect of the present disclosure, in a period including the reception time point of the transmission data, the search formula for the chronological database includes a search condition relevant to at least one of a transmission frequency in a plurality of associated transmission data pieces and a change degree of contents included in a payload.

In this aspect, since the search formula for the chronological database (the query definition file) includes a search condition relevant to the transmission frequency in the plurality of associated transmission data pieces or the change degree of the contents included in the payload, in the period including the reception time point of the transmission data, it is possible to efficiently specify (extract) the abnormal transmission data by using the chronological database.

(8) In the in-vehicle device according to one aspect of the present disclosure, the control unit generates report information on the basis of the information registered in the chronological database and the abnormality history database, and outputs the generated report information to an external server outside the vehicle.

In this aspect, the control unit of the in-vehicle device outputs the report information generated on the basis of the information registered in the chronological database and the abnormality history database, for example, to the external server such as a security operation center (SOC) server. The report information, for example, may be a daily report including summary information such as the number of registrations for each data type in the chronological database and the abnormality history database on a day-to-day basis, and a tendency relevant to the abnormal transmission data. The control unit of the in-vehicle device outputs the generated report information (the daily report) to the SOC server or the like, and thus, is capable of regularly providing useful information for improving in-vehicle security to SOC that holds jurisdiction over the SOC server or operates and manages the SOC server. The control unit of the in-vehicle device may extract the original data of the report information together with the report information from the chronological database and the abnormality history database, and output archive data in which the extracted original data is archived to the external server such as a SOC server. Accordingly, it is possible to construct a duplication DB of the chronological database and the abnormality history database in the SOC server.

(9) In the in-vehicle device according to one aspect of the present disclosure, the control unit specifies transmission data having attackability among the abnormal transmission data registered in the abnormality history database, and registers information relevant to the specified transmission data having attackability in an attack detection database.

In this aspect, the control unit of the in-vehicle device registers information relevant to the specified transmission data having attackability (attack information) from the abnormality information registered in the abnormality history database (the information relevant to the abnormal transmission data) in the attack detection database, as a part of the search processing, the analysis processing, and the like using the abnormality history database. Accordingly, it is possible to configure the attack detection database for storing only the abnormal transmission data having attackability, and perform the search processing, the analysis processing, and the like from various viewpoints by using the attack detection database, and the attack detection database corresponds to a black list in which information relevant to the transmission data having attackability is listed. As described above, by separating the chronological database, the abnormality history database, and the attack detection database for storing only the transmission data having attackability from each other, it is possible to perform normalization between the databases, and optimize each of the databases in accordance with attribute.

(10) In the in-vehicle device according to one aspect of the present disclosure, the control unit specifies the transmission data having attackability for the abnormality history database by using a search formula configured by combining a plurality of search conditions included in the search formula for the chronological database.

In this aspect, the control unit of the in-vehicle device uses the search formula configured by combining the plurality of search conditions included in the search formula for the chronological database for the abnormality history database. That is, for example, a search formula for the abnormality history database (a query definition file) may be generated in an AND condition in which a search condition for setting the transmission frequency to a predetermined value or more and a search condition for setting the change degree of the contents of the payload to a predetermined value or more (a rapid change) are combined, in the plurality of search conditions included in the search formula for the chronological database. As described above, by using the generated search formula for the abnormality history database, it is possible to efficiently extract (search) and specify the transmission data having attackability from the abnormality history database. The control unit of the in-vehicle device may specify the type of attack on the basis of the extracted (searched) plurality of transmission data pieces having attackability, and include the specified type of attack in the information relevant to the transmission data having attackability to be registered in the attack detection database (the black list). By including the type of attack in the information relevant to the transmission data having attackability to be registered in the attack detection database, it is possible to improve the reusability of the data registered in the attack detection database.

(11) In the in-vehicle device according to one aspect of the present disclosure, the control unit implements a countermeasure for the specified transmission data having attackability, and registers information relevant to the implemented countermeasure in association with the transmission data having attackability in the attack detection database.

In this aspect, the control unit of the in-vehicle device, for example, selects a suitable countermeasure such as the replacement of a MAC generation key, a change in CAN-ID used, a change in a relay route using a redundant circuit, or a transition to a fallback mode, on the basis of the type of attack in the transmission data having attackability, and implements the countermeasure. Alternatively, by broadcasting the information (the black list) registered in the attack detection database, the countermeasure may be transmitted to all the in-vehicle ECUs mounted on the vehicle. The implementation of the countermeasure by the control unit of the in-vehicle device is not limited to a countermeasure directly performed by the in-vehicle device itself, and the in-vehicle device, for example, may include a vehicle computer or the like, and include processing of transmitting an execution instruction of the countermeasure to an integrated ECU for controlling the entire vehicle. In this case, the integrated ECU that has received execution instruction from the in-vehicle device implements the countermeasure such as a change in the relay route. The control unit of the in-vehicle device implements the countermeasure for the transmission data having attackability specified by using the abnormality history database, and thus, is capable of softening the effect of the attack. The control unit of the in-vehicle device registers the information relevant to the implemented countermeasure in association with the transmission data having attackability in the attack detection database, and thus, is capable of improving the reusability of the data registered in the attack detection database.

(12) In the in-vehicle device according to one aspect of the present disclosure, the control unit outputs the information registered in the attack detection database to the external server outside the vehicle.

In this aspect, the control unit of the in-vehicle device outputs the information registered in the attack detection database (the attack information: the information relevant to the transmission data having attackability) to the external server such as a SOC server, and thus, is capable of regularly providing useful information for improving the security of the in-vehicle to SOC that hold jurisdiction over the SOC server or operates and manages the SOC server.

(13) A program according to one aspect of the present disclosure allows a computer connected to an in-vehicle ECU mounted on a vehicle such that communication is available to execute processing of receiving transmission data transmitted from the in-vehicle ECU, registering the received transmission data in association with a reception time point of the transmission data in a chronological database, specifying abnormal transmission data from the transmission data registered in the chronological database, and registering information relevant to the specified abnormal transmission data in an abnormality history database.

In this aspect, it is possible to allow the computer to function as an in-vehicle device that stores the data transmitted from the in-vehicle ECU in association with a temporal element such as the reception time point of the data, and efficiently performs the processing relevant to the data transmitted from the in-vehicle ECU by using the data associated with the temporal element.

(14) An information processing method according to one aspect of the present disclosure allows a computer connected to an in-vehicle ECU mounted on a vehicle such that communication is available to execute processing of receiving transmission data transmitted from the in-vehicle ECU, registering the received transmission data in association with a reception time point of the transmission data in a chronological database, specifying abnormal transmission data from the transmission data registered in the chronological database, and registering information relevant to the specified abnormal transmission data in an abnormality history database.

In this aspect, it is possible to provide the information processing method for allowing the computer to function as an in-vehicle device that stores the data transmitted from the in-vehicle ECU in association with a temporal element such as the reception time point of the data, and efficiently performs the processing relevant to the data transmitted from the in-vehicle ECU by using the data associated with the temporal element.

The present disclosure will be described in detail on the basis of the drawing illustrating an embodiment of the present disclosure. An in-vehicle device 2 according to the embodiment of the present disclosure will be described below with reference to the drawings. Note that, the present disclosure is not limited to the exemplification, but is indicated by the claims, and is intended to include all modifications within the meaning and the scope equivalent to the claims.

### Embodiment 1

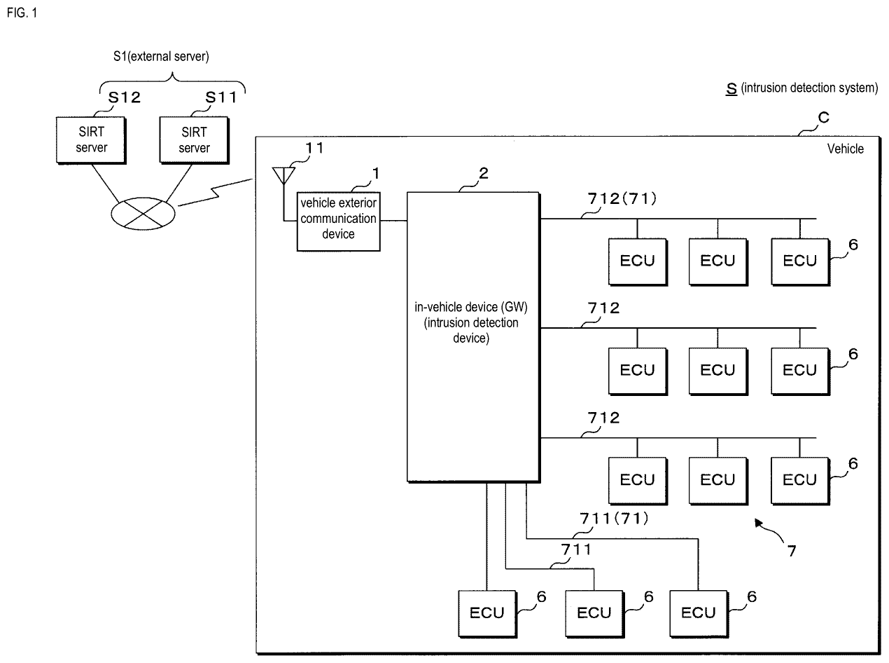

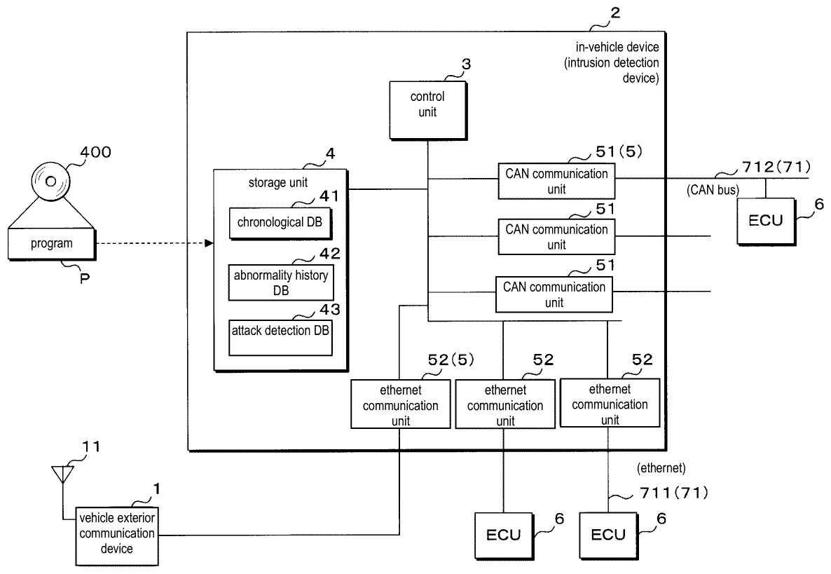

Hereinafter, the embodiment will be described on the basis of the drawings. FIG. 1 is a schematic view illustrating the configuration of an in-vehicle system S including an in-vehicle device 2 according to Embodiment 1. FIG. 2 is a block diagram illustrating a physical configuration of the in-vehicle device 2. The in-vehicle system S is configured by including the in-vehicle device 2 mounted on a vehicle C as a main device, and the in-vehicle device 2 is connected to an external server S1 such as a security operation center (SOC) server S11 or a security incident response team (SIRT) server S12 connected to a vehicle exterior network such as the Internet such that communication is available through a vehicle exterior communication device 1.

The in-vehicle device 2 functions as an intrusion detection device that receives (acquires) transmission data transmitted from all in-vehicle ECUs 6 mounted on the vehicle C, and detects whether the vehicle C is attacked by an attacker on the basis of the transmission data. In order to function as the intrusion detection device, the in-vehicle device 2 includes a plurality of databases according to a determination level with respect to the received transmission data. The details will be described below, but the plurality of databases include a chronological database 41, an abnormality history database 42, and an attack detection database 43, and by using data registered in such databases, the in-vehicle device 2 registers abnormal transmission data or transmission data having attackability among the received transmission data in the corresponding database. The in-vehicle device 2 may perform various countermeasures for the transmission data having attackability on the basis of the data registered in the attack detection database 43.

The external server S1, for example, is a computer such as a server connected to the vehicle exterior network such as the Internet or a public network, and includes the SOC server S11 and the SIRT server S12. The SOC server S11 is a server that is operated and managed by a security operation center (SOC), and is a server under the jurisdiction of an organization performing analysis or the like with respect to a security problem in the vehicle C. In a case where the transmission data having attackability is detected, the in-vehicle device 2 that functions as the intrusion detection device generates a black list in which the transmission data and the like are specified, and transmits the black list to the SOC server S11. The SIRT server S12 is a server operated and managed by a security incident response team (SIRT), and is a server under the jurisdiction of an organization developing and applying a program in which a countermeasure for an attack is performed on the basis of an analysis result of SOC, or the like. The SIRT server S12 may be an over the air (OTA) server providing an update program when performing program update processing (reprogramming).

In a case where the transmission data having attackability is detected, the in-vehicle device 2 that functions as the intrusion detection device may generate the black list in which the transmission data and the like are specified, and also transmit the black list to the SIRT server S12. Further, the in-vehicle device 2 may also transmit the data registered in the chronological database 41 and the abnormality history database 42 to the external server S1 such as the SIRT server S12.

The vehicle exterior communication device 1, the in-vehicle device 2, and a plurality of in-vehicle ECUs 6 for controlling various in-vehicle devices (an actuator and a sensor) are mounted on the vehicle C. The vehicle exterior communication device 1 and the in-vehicle device 2, for example, are connected by a harness such as a serial cable such that communication is available. The in-vehicle device 2 and the in-vehicle ECU 6 are connected by an in-vehicle network 7 corresponding to a communication protocol such as a control area network (CAN) or Ethernet (registered trademark) such that communication is available.

The vehicle exterior communication device 1 includes a vehicle exterior communication unit (not illustrated) and an input/output interface (I/F) (not illustrated) for communicating with the in-vehicle device 2. The vehicle exterior communication unit is a communication device for wireless communication using a mobile communication protocol such as LTE, 4G, 5G, and WiFi, and transmits and receives data with respect to the external server S1 through an antenna 11 connected to the vehicle exterior communication unit. The communication between the vehicle exterior communication device 1 and the external server S1, for example, is performed through an external network such as a public network or the Internet.

The in-vehicle device 2 functions as the intrusion detection device. The in-vehicle device 2 that functions as the intrusion detection device may function as a relay device (GW) such as a CAN gateway or an Ethernet SW (layer 2 switch or layer 3 switch). By implementing the function of the intrusion detection device on the in-vehicle device 2 (the relay device: GW) illustrated in this embodiment, it is possible to reliably acquire the data (the transmission data) transmitted from all the in-vehicle ECUs 6 connected to the in-vehicle network 7.

The in-vehicle device 2 may be a power lan box (PLB) that also functions as a power distribute device performing the distribution and relay of power output from a power-supply device such as a secondary battery, in addition to relay relevant to communication, and supplying the power to the in-vehicle device such as an actuator connected to the own device (in-vehicle device 2). Alternatively, the in-vehicle device 2 may be configured as one function unit of a body ECU controlling the entire vehicle C. Alternatively, the in-vehicle device 2, for example, may be an integrated ECU that is configured as a central control device such as a vehicle computer, and performs overall control of the vehicle C. That is, the integrated ECU, as a part of the function thereof, may perform processing relevant to intrusion detection described in this embodiment.

The in-vehicle device 2 includes a control unit 3, a storage unit 4, and a vehicle interior communication unit 5. The control unit 3 includes a central processing unit (CPU), a micro processing unit (MPU), or the like, reads out and executes a control program P (a program product) and data stored in advance in the storage unit 4 to perform various control processing pieces, arithmetic processing pieces, and the like.

The storage unit 4 includes a volatile memory element such as a random access memory (RAM), or a non-volatile memory element such as a read only memory (ROM), an electrically erasable programmable ROM (EEPROM), or a flash memory, and stores in advance the control program P and the data referred to in the processing. As the control program P (the program product) stored in the storage unit 4, a control program P (a program product) read out from a recording medium 400 readable by the in-vehicle device 2 may be stored. In addition, the control program P may be downloaded from an external computer (not illustrated) connected to a communication network (not illustrated), and stored in the storage unit 4. In the storage unit 4, the chronological database 41, the abnormality history database 42, and the attack detection database 43 are stored. Further, a query definition file in which a search formula (a query) with respect to such databases is described (defined) is stored in the storage unit 4. The details of such databases will be described below.

The vehicle interior communication unit 5, for example, is an input/output interface using a communication protocol such as a control area network (CAN), a CAN with flexible data rate (CAN-FD), or Ethernet (TCP/IP). The vehicle interior communication unit 5 includes a CAN communication unit 51 configured as a CAN transceiver, and an Ethernet communication unit 52 configured as an Ethernet PHY part, and functions as a communication unit corresponding to a physical layer for communication between the in-vehicle device 2 and the in-vehicle ECU 6.

A plurality of vehicle interior communication units 5 are provided, and the vehicle interior communication units 5 are connected to communication lines 71 (Ethernet cables 711 and CAN buses 712) configuring the in-vehicle network 7, that is, buses, respectively. As described above, by providing the plurality of vehicle interior communication units 5, the in-vehicle network 7 may be divided into a plurality of buses or segments, and the in-vehicle ECU 6 may be connected to each of the buses or the like in accordance with the function of the in-vehicle ECU 6. The control unit 3 of the in-vehicle device 2 communicates with the in-vehicle ECU 6 connected to the in-vehicle network 7 through the vehicle interior communication unit 5.

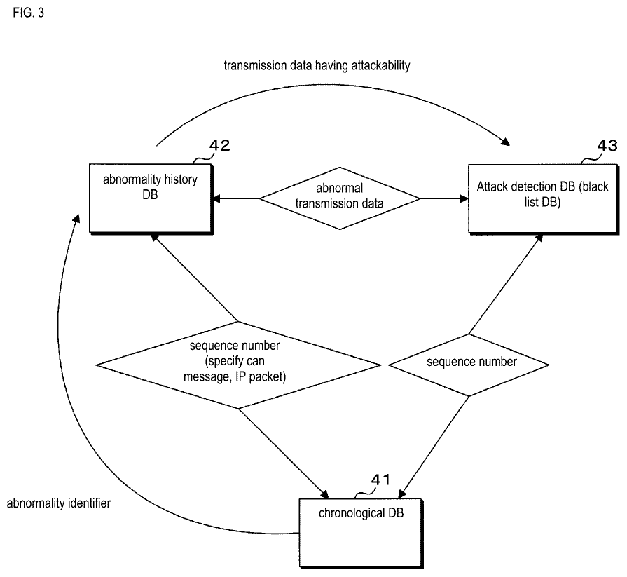

FIG. 3 is an explanatory diagram (an ER diagram) illustrating various databases stored in the storage unit 4 of the in-vehicle device 2. The chronological database 41, the abnormality history database 42, and the attack detection database 43 are stored in the storage unit 4 of the in-vehicle device 2, and such databases (DB) are configured by database management software such as one or a plurality of relational database management systems (RDBMS) installed in the in-vehicle device 2. By configuring the chronological database 41, the abnormality history database 42, and the attack detection database 43 using the RDBMS, it is possible to issue a processing command of search processing with respect to such databases by using a query description language such as a structured query language (SQL).

In this embodiment, the chronological database 41, for example, is configured by TimescaleDB (Registered Trademark). The abnormality history database 42 and the attack detection database 43, for example, are configured by Postgrasql (Registered Trademark). In order to register (insert) data in Postgrasql, a log relevant to the acquired transmission data may be formatted by using Fluentd (Registered Trademark) or Embulk (Registered Trademark).

In the chronological database 41, the transmission data determined as normal when received by the in-vehicle device 2 is registered in association with a reception time point of the transmission data. In the abnormality history database 42, the transmission data determined as abnormal when received by the in-vehicle device 2 is registered in association with reception time point of the transmission data. In the chronological database 41, all the transmission data including not only the normal transmission data but also the abnormal transmission data may be registered in association with the reception time point of the transmission data.

In the abnormality history database 42, among the transmission data stored in the chronological database 41, transmission data (abnormal data) specified as abnormal by a search formula executed on the chronological database 41 (search formula for the chronological database 41) is registered. In the attack detection database 43, among the transmission data (the abnormal data) stored in the abnormality history database 42, transmission data (attack data) specified as having attackability by a search formula executed on the attack detection database 43 (search formula for the abnormality history database 42) is registered.

In the chronological database 41 and the abnormality history database 42, for example, relevance (relation) is set by a sequence number for uniquely specifying a CAN message or an IP packet that is transmission data. In the abnormality history database 42 and the attack detection database 43, for example, relevance (relation) is set by an abnormality identifier, a sequence number, and the like. In the chronological database 41 and the attack detection database 43, for example, relevance (relation) is set by a sequence number.

Such three databases are separated from each other, but have relevance to each other and are stored in the storage unit 4 of the in-vehicle device 2, and thus, it is possible to perform normalization between the databases, and optimize each of the databases in accordance with the attribute. In this embodiment, such three databases are configured by an individual RDBMS or the like, but are not limited thereto, and may be configured by a single RDBMS, or may be formed by a table corresponding to each of the databases.

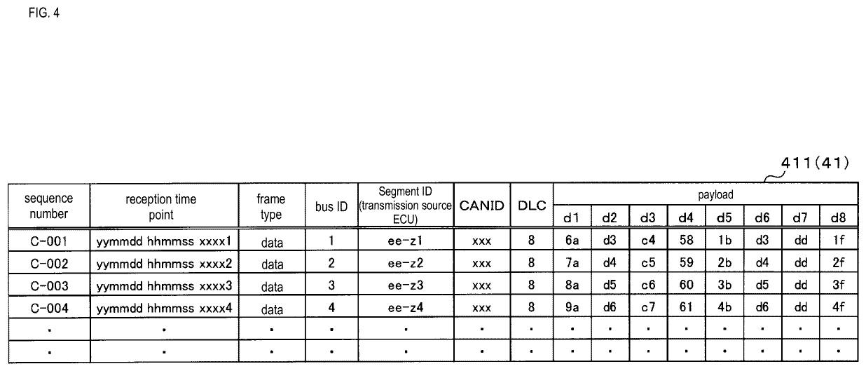

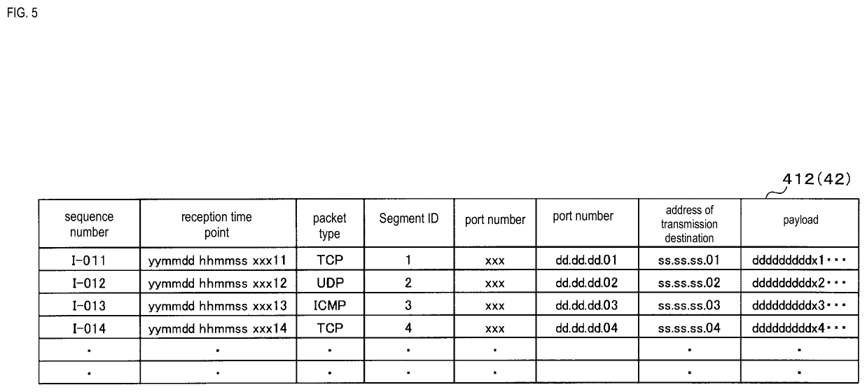

FIG. 4 is an explanatory diagram illustrating the chronological database 41 (CAN message table 411). FIG. 5 is an explanatory diagram illustrating the chronological database 41 (IP packet table 412). The chronological database 41, for example, includes the CAN message table 411 and the IP packet table 412, and may be configured by different tables according to a communication protocol of the transmission data transmitted and received between the in-vehicle ECUs 6.

In the CAN message table 411 (chronological database 41), information relevant to the CAN message received by the in-vehicle device 2 is registered. The CAN message table 411 (chronological database 41), as a management item (field), for example, includes a sequence number, a reception time point, a frame type, a bus ID, a segment ID (a transmission source ECU), CANID, DLC, and d1 to d8 indicating a value in a byte unit in a payload.

In the management item of the sequence number, a management number uniquely indicating the received transmission data is stored. The management number, for example, may be given by a sequential number or the like, and used as a primary key.

In the management item of the reception time point, information relevant to a temporal element when the transmission data is received by the in-vehicle device 2, such as a reception time or a timestamp of the transmission data, is stored.

In the management item of the frame type, the frame type of the transmission data that is the CAN message, such as a data frame, a remote frame, an overload frame, and an error frame, is stored.

In the management item of the bus ID, the number (the bus ID) of the CAN bus 712 to which the in-vehicle ECU 6 that has transmitted the transmission data is connected is stored. The number of the CAN bus 712 corresponds to the device number of the CAN communication unit 51, and the device number of the CAN communication unit 51 may be stored.

In the management item of the segment ID (the transmission source ECU), an identification number indicating the transmission source ECU, such as an ECU number for specifying the in-vehicle ECU 6 that has transmitted the transmission data, is stored. As described above, by storing the identification number indicating the transmission source ECU in the management item, it is possible to efficiently determine which in-vehicle ECU 6 transmits the transmission data (the message) that frequently causes abnormality.

In the management item of CANID, the message ID (CAN-ID) of the transmission data that is the CAN message is stored. In the management item of DLC, the data length (0 to 8 bytes) of the payload in the transmission data that is the CAN message is stored. In the management item of each of d1 to d8 indicating the value in the byte unit in the payload, each of the values included in the payload is stored. The management item (field) included in the CAN message table 411 is not limited to the above items, and may further include a CRC value and a MAC value.

In the IP packet table 412 (chronological database 41), information relevant to the IP packet received by the in-vehicle device 2 is registered. The IP packet table 412 (chronological database 41), as the management item (field), for example, includes a sequence number, a reception time point, a packet type, a segment ID, a port number, the address of the transmission source, the address of a transmission destination, and a payload.

In the management item of the sequence number, a management number uniquely indicating the received transmission data is stored. The management number, for example, may be given by a sequential number or the like, and used as a primary key.

In the management item of the reception time point, information relevant to a temporal element when the transmission data is received by the in-vehicle device 2, such as the reception time or the timestamp of the transmission data, is stored.

In the management item of the packet type, the packet type of the transmission data that is the IP packet, such as TCP, UDP, and ICMP, is stored.

In the management item of the segment ID, the segment number (the segment ID) of the Ethernet cable 711 to which the in-vehicle ECU 6 that has transmitted the transmission data is connected is stored. The segment ID corresponds to the device number of the Ethernet communication unit 52, and the device number of the Ethernet communication unit 52 may be stored.

In the management item of the port number, a port number such as the TCP port number or the UDP port number of the transmission data that is the IP packet is stored. In the management item of the address of the transmission source, the IP address (the source address) of the in-vehicle ECU 6 that has transmitted the transmission data is stored. In the management item of the address of the transmission destination, the IP address (the destination address) of the in-vehicle ECU 6 to be the transmission destination of the transmission data is stored.

In the management item of the payload, the value or the contents included in the payload are stored. The management item (field) included in the IP packet table 412 is not limited to the above items, and may further include a CRC value and a MAC value.

In this embodiment, the chronological database 41 includes the CAN message table 411 and the IP packet table 412, but is not limited thereto, and may include a single table (database). Alternatively, the chronological database 41 may include either the CAN message table 411 or the IP packet table 412.

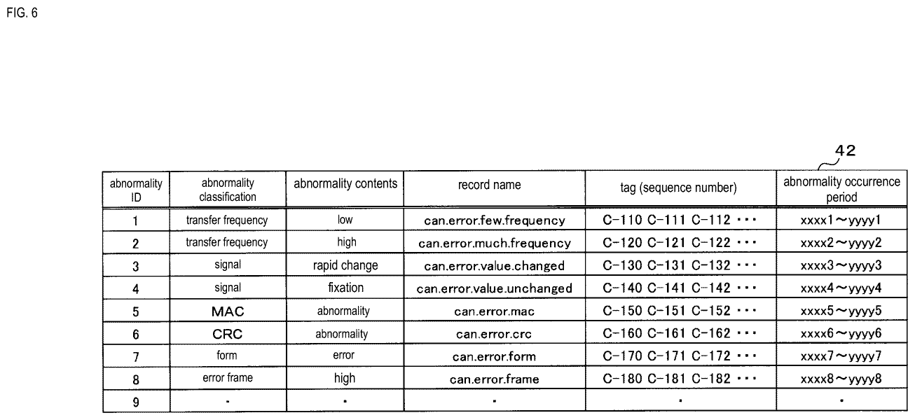

FIG. 6 is an explanatory diagram illustrating the abnormality history database 42. The abnormality history database 42, as a management item (field), for example, includes an abnormality ID, abnormality classification, abnormality contents, a record name, a tag (a sequence number), and an abnormality occurrence period.

In the management item of the abnormality ID, a management number uniquely indicating information (a record) relevant to the specified abnormality is stored. The management number, for example, may be given by a sequential number or the like, and used as a primary key.

In the management item of the abnormality classification, the classification of the abnormality in the specified abnormal transmission data, such as a transfer frequency, a signal, MAC, CRC, a form, and an error frame, is stored.

In the management item of the abnormality contents, abnormality contents corresponding to a value stored in the management item of the abnormality classification (the classification of the abnormality) are stored. The abnormality contents, for example, include various contents corresponding to the abnormality classification, such as a high or low transfer frequency, a rapid change or fixation in a signal (the value of a payload), MAC abnormality, CRC abnormality, a form error, and a large number of error frames.

In the management item of the record name, a record name corresponding to a combination between the abnormality classification and the abnormality contents is stored.

In the management item of the tag (the sequence number), one or more sequence numbers indicating the specified abnormal transmission data pieces, respectively, are stored. On the basis of the sequence number, it is possible to specify the transmission data stored in the chronological database 41. Alternatively, in the management item of the tag (the sequence number), CANID, the reception time point, the payload, and the like of the specified abnormal transmission data may be stored.

In the management item of the abnormality occurrence period, a period where abnormality occurs due to the specified abnormal transmission data is stored. In a case where there are a plurality of specified abnormal transmission data pieces, the period where the abnormality occurs may be from the oldest reception time point to the newest reception time point in the plurality of abnormal transmission data pieces.

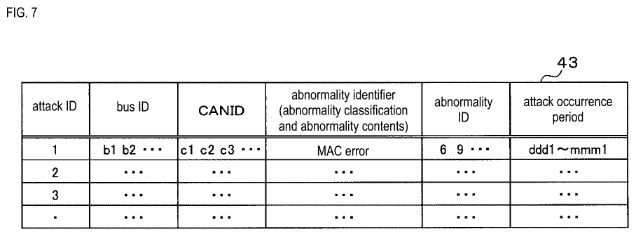

FIG. 7 is an explanatory diagram illustrating the attack detection database 43. The attack detection database 43, as a management item (field), for example, includes an attack ID, a bus ID, CANID, an abnormality identifier (abnormality classification and abnormality contents), an abnormality ID, and an attack occurrence period.

In the management item of the attack ID, a management number uniquely indicating information (a record) relevant to the specified attack is stored. The management number, for example, may be given by a sequential number or the like, and used as a primary key.

In the management item of the bus ID, a bus ID or a segment ID to which the in-vehicle ECU 6 that has transmitted the transmission data having attackability is connected is stored.

In the management item of CANID, in a case where the transmission data having attackability is the CAN message, the message ID (CAN-ID) of the CAN message is stored. In a case where the transmission data having attackability is the IP packet, the port number of the IP packet may be stored. Alternatively, the attack detection database 43 may include a management item for a port number.

In the management item of the abnormality identifier (abnormality classification and abnormality contents), for example, abnormality classification and abnormality contents in the transmission data having attackability, such as a MAC error, are stored. In the management item of the abnormality ID, in order to specify the transmission data having attackability, an abnormality ID extracted from the abnormality history database 42 is stored. By using the abnormality ID, it is possible to specify the abnormal transmission data registered in the abnormality history database 42, and thus, it is possible to specify the reception time point, the record name, and the like of the abnormal transmission data. Alternatively, in the management item of the abnormality ID, the reception time point, the record name, and the like of one or more abnormal transmission data pieces extracted from the abnormality history database 42 may be stored by specifying the transmission data having attackability.

In the management item of attack occurrence period, a period where an attack occurs due to the specified transmission data having attackability is stored. In a case where there are a plurality of specified transmission data pieces having attackability, the period where the attack occurs may be from the oldest reception time point to the newest reception time point in the plurality of transmission data pieces having attackability.

The attack detection database 43 may further include a management item (a countermeasure) storing a countermeasure implemented for the specified attack. In the management item of the countermeasure, as the countermeasure implemented in accordance with the specified attack, for example, the simultaneous notification of the black list, the replacement of a MAC generation key, a change in CAN-ID used, a change in a relay route using a redundant circuit, a transition to a fallback mode, and the like may be stored.

As described above, in the attack detection database 43, the information relevant to the transmission data having attackability is listed (black-listed) and stored, and the attack detection database 43 corresponds to a black list database storing the black list. The control unit 3 of the in-vehicle device 2 is capable of efficiently generating the black list in which the information relevant to the transmission data having attackability is listed with reference to the attack detection database 43.

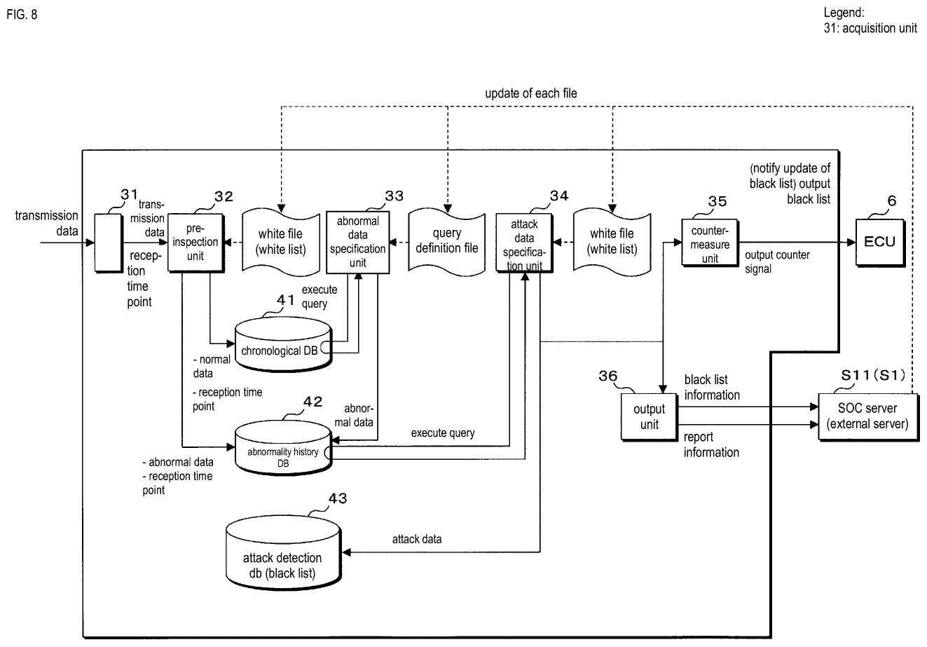

FIG. 8 is a functional block diagram illustrating function units included in the control unit 3 of the in-vehicle device 2. The control unit 3 of the in-vehicle device 2 functions as an acquisition unit 31, a pre-inspection unit 32, an abnormal data specification unit 33, an attack data specification unit 34, a countermeasure unit 35, and an output unit 36 by executing the control program P stored in the storage unit 4.

The acquisition unit 31 acquires (receives) the transmission data such as a CAN message or an IP packet through the vehicle interior communication unit 5 according to each communication protocol (CAN, TCP/IP, or the like), such as the CAN communication unit 51 and the Ethernet communication unit 52. In a case where the in-vehicle device 2 functions as a relay device, the transmission data flowing through all the communication lines 71 (Ethernet cables 711 and CAN buses 712) configuring the in-vehicle network 7 can be acquired (received). The acquisition unit 31 outputs the acquired (received) transmission data in association with the reception time point of the transmission data such as the reception time or the timestamp to the pre-inspection unit 32.

For the transmission data from the acquisition unit 31, the pre-inspection unit 32 determines whether the transmission data is normal or abnormal. The pre-inspection unit 32, for example, may perform right or wrong determination of the transmission data with reference to the white list indicating a normal data list set in advance. The white list, for example, is stored in a storage area accessible by the pre-inspection unit 32 (control unit 3), such as the storage unit 4 of the in-vehicle device 2, and in the white list, information indicating the normal transmission data is listed. The information indicating the normal transmission data, for example, includes CAN-ID (the message ID), the range of the value in the payload, or the like, in CAN, and for example, includes the port number, the address of the transmission source, the address of the transmission destination, or the like, in TCP/IP.

The pre-inspection unit 32 compares the transmission data with the white list, determines that the received transmission data is normal in a case where the transmission data corresponds to the information indicating the normal transmission data included in the white list, and determines that the transmission data is abnormal in a case where the transmission data does not correspond to the information. The pre-inspection unit 32 may further determine that the transmission data is abnormal in a case where an error is detected in at least one of an authorization code (MAC), an inspection code (CRC), and a form (a form in which an error is detected when a rogue bit is included in a field with a fixed bit number) included in the transmission data from the acquisition unit 31. As described above, the pre-inspection unit 32 may perform various right or wrong determinations with respect to single received transmission data, and combine each right or wrong determination result or a plurality of right or wrong determination results to determine whether the transmission data is normal or abnormal.

In a case where the in-vehicle device 2 includes a hardware security module (HSM), the pre-inspection unit 32 may acquire a processing result by the HSM, or determine the presence or absence of an error in MAC in cooperation with HSM.

The pre-inspection unit 32 registers (inserts) the transmission data determined as normal in association with the reception time point of the transmission data in the chronological database 41. The pre-inspection unit 32 may register the transmission data in the CAN message table 411 or the IP packet table 412 in accordance with the communication protocol of the transmission data.

The pre-inspection unit 32 registers (inserts) the transmission data determined as abnormal in association with the reception time point of the transmission data in the abnormality history database 42. The pre-inspection unit 32 may also register the transmission data determined as abnormal in the chronological database 41 as with the transmission data determined as normal.

In this embodiment, the chronological database 41, as an example, is capable of performing an aggregate calculation in processing unit such as 10 milliseconds, for example, by using RDBMS storing data to be registered in a table referred to as a chunk internally divided by time and a space, such as TimescaleDB. Accordingly, it is possible to make a temporal granularity in a plurality of transmission data pieces to be registered fine, and improve resolution in search or the like using the temporal element such as a reception time point.

The abnormal data specification unit 33 cyclically extracts the plurality of transmission data pieces for the chronological database 41 by using the search formula for the chronological database 41 (query for the chronological database 41), and specifies the abnormal transmission data on the basis of an extraction result of the plurality of transmission data pieces. The search formula for the chronological database 41, for example, is stored in the storage unit 4 as the query definition file defined by using the query description language such as a structured query language (SQL). The abnormal data specification unit 33 reads out the query definition file with reference to the storage unit 4 to execute the processing command based on the search formula for the chronological database 41 on the chronological database 41. The query definition file (search formula for the chronological database 41), for example, may be acquired from the external server S1 such as the SOC server S11. The search formula for the chronological database 41, for example, includes a search formula (a query) for extracting (defining) whether a transmission frequency (a reception frequency) in the plurality of transmission data pieces with the same or related CANID is a threshold value or more or less than the threshold value, or a change rate in the value of the signal (the payload) of the transmission data is a threshold value or more or less than the threshold value.

In a case where the transmission frequency (the transfer frequency) is low (less than the threshold value), the abnormal data specification unit 33 may determine that there is a failure in a specific device. In a case where the transmission frequency (the transfer frequency) is high (the threshold value or more), the abnormal data specification unit 33 may determine that an impersonation occurs or there is a failure in the device. In a case where the signal (the payload) is rapidly changed (the change rate is the threshold value or more), the abnormal data specification unit 33 may determine that an impersonation occurs or there is a failure in the device. For example, in a case where the signal is fixed (the change rate is less than the threshold value), such as a case where the value of the signal (the payload) is continuously constant, the abnormal data specification unit 33 may determine that an impersonation occurs or there is a failure in the device. Further, the search formula for the chronological database 41 may include the search formula (the query) for extracting the sequence abnormality of a unified diagnostic service (UDS) or reprogramming. Further, the search formula for the chronological database 41 may include a search formula (a query) for extracting the presence or absence of connection from an unknown transmission source. As described above, the search formula for the chronological database 41 may be configured by a combination (OR search) of logical OR of a plurality of search formulae (search conditions) for specifying the abnormal transmission data. The abnormal data specification unit 33 registers the information relevant to the specified abnormal transmission data (the abnormal data) in the abnormality history database 42.

The abnormal data specification unit 33 may perform the search processing using the search formula for the chronological database 41 with respect to the chronological database 41, and perform registration processing with respect to the abnormality history database 42 according to the processing result, at a predetermined cycle. In this case, the cycle may be longer than the frequency (the reception frequency) for acquiring (receiving) the transmission data by the acquisition unit 31. That is, the processing of the abnormal data specification unit 33 that is cyclically performed, and the processing of receiving the transmission data by the acquisition unit 31 may be asynchronously performed.

The attack data specification unit 34 cyclically extracts the plurality of abnormal transmission data for the abnormality history database 42 by using the search formula for the abnormality history database 42 (query for the abnormality history database 42), and specifies the transmission data having attackability on the basis of the extraction result of the plurality of abnormal transmission data. The search formula for the abnormality history database 42, for example, is stored in the storage unit 4 as the query definition file defined by using the query description language such as a structured query language (SQL). The attack data specification unit 34 reads out the query definition file with reference to the storage unit 4 to execute the processing command based on the search formula for the abnormality history database 42 on the abnormality history database 42. The query definition file (search formula for the abnormality history database 42), for example, may be acquired from the external server S1 such as the SOC server S11.

The search formula for the abnormality history database 42 may be configured by combining a plurality of search conditions included in the search formula for the chronological database 41. For example, the search formula for the abnormality history database 42 (the query definition file) may be generated in an AND condition (logical AND) or an OR condition (logical OR) in which a search condition for setting the transmission frequency to a predetermined value or more and a search condition for setting the change degree of the contents of the payload to a predetermined value or more (a rapid change) are combined, in the plurality of search conditions included in the search formula for the chronological database 41.

For example, in a case where the abnormality classification and the abnormality contents are the MAC abnormality or the form error, the attack data specification unit 34 determines that an attack due to an impersonation occurs, and specifies that the abnormal transmission data of the MAC abnormality or the form error is the transmission data having attackability. For example, in a case where the abnormality classification and the abnormality contents are the high transmission frequency (transfer frequency) and the rapid change in the signal, the attack data specification unit 34 determines that an attack due to an impersonation occurs, and specifies that the abnormal transmission data of the MAC abnormality or the form error is the transmission data having attackability. For example, in a case where the abnormality classification and the abnormality contents are the low transmission frequency (transfer frequency) and the large number of error frames, the attack data specification unit 34 determines that an attack due to an impersonation occurs, and specifies the abnormal transmission data of the MAC abnormality or the form error is the transmission data having attackability. For example, in a case where the abnormality classification and the abnormality contents are the CRC abnormality and the fixation in the signal, the attack data specification unit 34 determines that a failure (a failure due to an attack) in a device occurs, and specifies that the abnormal transmission data of the MAC abnormality or the form error is the transmission data having attackability.

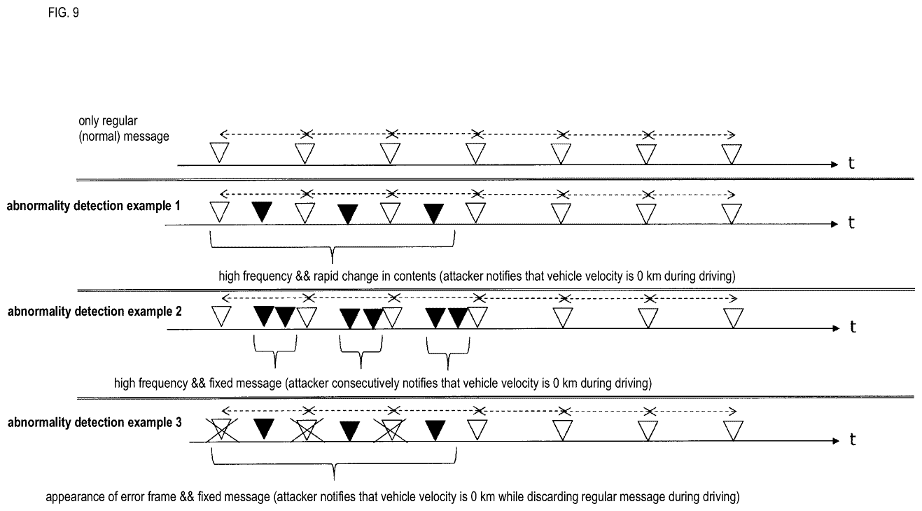

FIG. 9 is an explanatory diagram illustrating an attack detection mode. In this explanatory diagram, a horizontal axis indicates an elapsed time, and a mode example to be an example of the abnormality detection for specifying the transmission data having attackability is described. A normal message (a regular message) is indicated by a white triangle. The transmission data having attackability (the abnormal transmission data) is indicated by a black triangle.

In Abnormality Detection Example 1, a case is illustrated in which the transmission frequency (the transfer frequency) is high and the signal (the contents of the payload) is rapidly changed, which is due to an attack in which the attacker (in-vehicle ECU 6 or the like to which a rogue program is applied by a virus or the like), for example, transmits (notifies) the transmission data indicating that a vehicle velocity is 0 km while the vehicle C is being driven.

In Abnormality Detection Example 2, a case is illustrated in which the transmission frequency (the transfer frequency) is high and the signal (the contents of the payload) is fixed, which is due to an attack in which the attacker, for example, consecutively transmits (notifies) the transmission data indicating that the vehicle velocity is 0 km while the vehicle C is being driven.

In Abnormality Detection Example 3, a case is illustrated in which the error frame appears and the signal (the contents of the payload) is fixed, which is due to an attack in which the attacker, for example, transmits (notifies) the transmission data indicating the vehicle velocity is 0 km while discarding the normal message (the regular message), while the vehicle C is being driven.

As described above, the search formula for the attack detection database 43 is configured by a combination of the logical OR or the logical AND of the plurality of search formulae (search conditions) for specifying the transmission data having attackability, and thus, is capable of determining the presence or absence of the attack from a set of the consecutive abnormal transmission data pieces. Alternatively, the in-vehicle ECU 6 or the like that is an attack source transmitting the transmission data can be specified from the connection between the plurality of abnormal transmission data pieces. The attack data specification unit 34 registers the specified information relevant to the transmission data having attackability in the attack detection database 43.

The attack data specification unit 34 may perform the search processing with respect to the abnormality history database 42 using the search formula for the abnormality history database 42 and the registration processing with respect to the attack detection database 43 according to the processing result, at a predetermined cycle. In this case, the cycle may be the same as or different from the cycle of the processing by the abnormal data specification unit 33. Alternatively, in a case where the abnormal transmission data is specified by the abnormal data specification unit 33, the attack data specification unit 34 may perform the search processing or the like with respect to the abnormality history database 42 with the specification of the abnormal transmission data as a trigger. By linking the processing of the attack data specification unit 34 to the processing result of the abnormal data specification unit 33, it is possible to suppress excessive processing, and reduce the processing load of the control unit 3.

The countermeasure unit 35 selects a countermeasure to be implemented in accordance with the transmission data having attackability that is specified by the attack data specification unit 34 and registered in the attack detection database 43, and performs processing for performing the selected countermeasure. The countermeasure unit 35 may select the countermeasure to be implemented in accordance with the type of attack according to the transmission data having attackability. In the countermeasure, for example, the black list in which the identifier such as CAN-ID or the port number included in the transmission data, and the address of the in-vehicle ECU 6 that is the transmission source is listed may be generated on the basis of the specified information relevant to the transmission data having attackability, and the black list may be broadcasted to be transmitted to all the in-vehicle ECUs 6 mounted on the vehicle C.

The countermeasure unit 35 is capable of efficiently generating the black list with reference to the attack detection database 43 in which the information relevant to the transmission data having attackability is registered. Further, the countermeasure unit 35, for example, may select various countermeasures such as the replacement of the MAC generation key, the change in CAN-ID used, the change in the relay route using the redundant circuit, or the transition to the fallback mode, in accordance with the type of attack, and execute the countermeasures.

The implementation of the countermeasure is not limited to the countermeasure directly performed by the countermeasure unit 35 (in-vehicle device 2 itself), and may include processing for the countermeasure unit 35, for example, to transmit an execution instruction (a counter signal) of the countermeasure to the integrated ECU including the vehicle computer or the like. In this case, the integrated ECU that has received the execution instruction (the counter signal) from the countermeasure unit 35 implements the countermeasure of which the execution is instructed, such as the change in the relay route. The countermeasure unit 35 may register information relevant to the countermeasure implemented in accordance with the transmission data having attackability in association with the transmission data in the attack detection database 43.

The output unit 36 outputs an attack detection report (black list information) including the black list generated on the basis of the information relevant to the transmission data having attackability that is specified by the attack data specification unit 34 and registered in the attack detection database 43, for example, to the SOC server S11, the SIRT server S12, both of the servers, or the like. When the transmission data having attackability is specified by the attack data specification unit 34, with the specification as a trigger, the output unit 36 may output the black list information to the external server S1 such as the SOC server S11. Accordingly, it is possible to improve the real-time properties of the attack detection report with respect to the SOC server S11 or the like.

Further, the output unit 36 may output report information generated on the basis of the information registered in the chronological database 41 and the abnormality history database 42 to the external server S1 such as the SOC server S11. The output unit 36 may generate and output the report information, for example, once a day by scheduling the generation and the output as a daily task. For example, in a case where the report information is generated on a day-to-day basis, the output unit 36 may generate the report information on a date to be a target of the report information by including statistical information such as the number of transmission data pieces registered in the chronological database 41 and the abnormality history database 42, a change rate with respect to the number of transmission data pieces up to the previous day, and a moving average of the number of transmission data pieces in a plurality of past days.

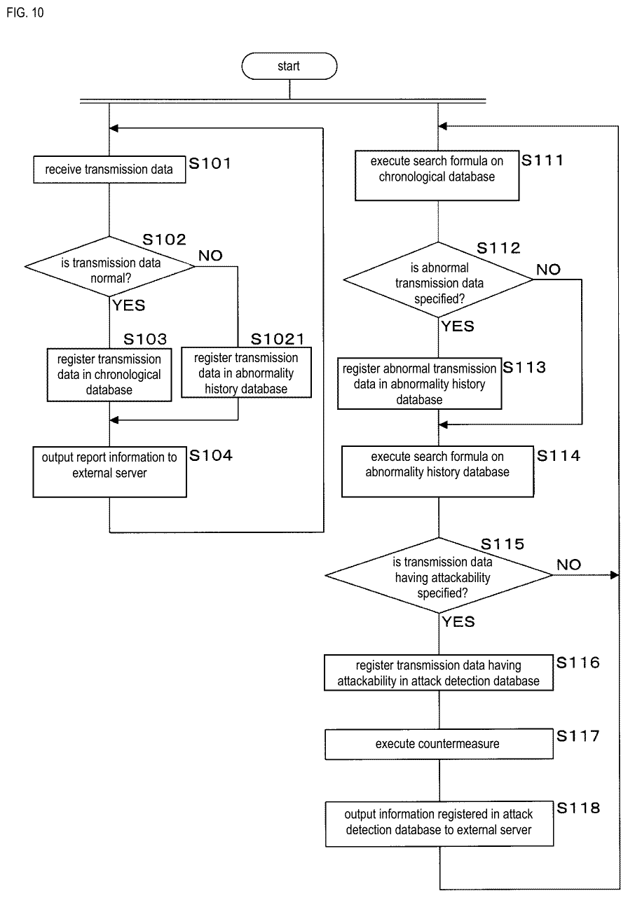

FIG. 10 is a flowchart illustrating the processing of the control unit 3 of the in-vehicle device 2. The control unit 3 of the in-vehicle device 2, for example, routinely performs the following processing when the vehicle C is in a starting state or a pausing state (an IG switch is turned on or off). The control unit 3 of the in-vehicle device 2, in a set of the following processing pieces, may perform processing (S101 to S104) of registering the received transmission data in the chronological database 41 and the like, and processing (S111 to S118) of registering the received transmission data in the attack detection database 43 in accordance with a result of searching (query processing) the chronological database 41 and the abnormality history database 42 in parallel by a plurality of processes.

The control unit 3 of the in-vehicle device 2 receives the transmission data transmitted from the in-vehicle ECU 6 (S101). The control unit 3 of the in-vehicle device 2 acquires (receives) the transmission data such as the CAN message or the IP packet through the vehicle interior communication unit 5 corresponding to each of the communication protocols, such as the CAN communication unit 51 and the Ethernet communication unit 52.

The control unit 3 of the in-vehicle device 2 determines whether the received transmission data is normal (S102). The control unit 3 of the in-vehicle device 2, for example, determines whether the transmission data is normal on the basis of the presence or absence of an error in the authorization code (MAC), the inspection code (CRC), or the form included in the transmission data, with reference to the white list.

In a case where the received transmission data is normal (S102: YES), the control unit 3 of the in-vehicle device 2 registers the transmission data determined as normal in association with the reception time point of the transmission data in the chronological database 41 (S103). In a case where the transmission data is included in the white list or there is no error in the authorization code (MAC), the inspection code (CRC), and the form included in the transmission data, the control unit 3 of the in-vehicle device 2 determines that the received transmission data is normal, and registers the transmission data in association with the reception time point of the transmission data in the chronological database 41.

In a case where the received transmission data is not normal (S102: NO), that is, in a case where the received transmission data is abnormal, the control unit 3 of the in-vehicle device 2 registers the transmission data determined as abnormal in association with the reception time point of the transmission data in the abnormality history database 42 (S1021). In a case where the transmission data is not included in the white list or there is an error in any of the authorization code (MAC), the inspection code (CRC), and the form included in the transmission data, the control unit 3 of the in-vehicle device 2 determines that the received transmission data is abnormal, and registers the transmission data in association with the reception time point of the transmission data in the abnormality history database 42.

The control unit 3 of the in-vehicle device 2 outputs the report information generated on the basis of the information registered in the chronological database 41 and the abnormality history database 42 to the external server S1 (S104). The control unit 3 of the in-vehicle device 2, for example, generates the report information (daily report information) on the basis of the information registered in the chronological database 41 and the abnormality history database 42 at a frequency such as once a day, and outputs (transmits) the generated report information to the external server S1 such as the SOC server S11. The control unit 3 of the in-vehicle device 2 performs loop processing of executing again the processing from S101 after the execution of S104.

The control unit 3 of the in-vehicle device 2 executes the search formula (the query) on the chronological database 41 (S111). The control unit 3 of the in-vehicle device 2 cyclically executes the search formula for the chronological database 41 (query for the chronological database 41) on the chronological database 41, and extracts the plurality of transmission data pieces to be a search result.

The control unit 3 of the in-vehicle device 2 determines whether to specify the abnormal transmission data on the basis of an execution result of the search formula with respect to the chronological database 41 (S112). The control unit 3 of the in-vehicle device 2 determines whether to specify the abnormal transmission data on the basis of the extraction result of the plurality of transmission data pieces to be the execution result of the search formula with respect to the chronological database 41.

In a case where the abnormal transmission data is specified (S112: YES), the control unit 3 of the in-vehicle device 2 registers the specified abnormal transmission data in the abnormality history database 42 (S113). For example, in the case of extracting the plurality of transmission data pieces in which the transmission frequency (the reception frequency) in the plurality of transmission data pieces with the same or related CANID is the threshold value or more or less than the threshold value, or the change rate in the value of the signal (the payload) of the transmission data is the threshold value or more or less than the threshold value, the control unit 3 of the in-vehicle device 2 specifies the transmission data as the abnormal transmission data, and registers the transmission data in the abnormality history database 42.

In a case where the abnormal transmission data is not specified (S112: NO), or after the processing of S113 is executed, the control unit 3 of the in-vehicle device 2 executes the search formula (the query) on the abnormality history database 42 (S114). The control unit 3 of the in-vehicle device 2 cyclically executes the search formula for the abnormality history database 42 (query for the abnormality history database 42) on the abnormality history database 42, and extracts the plurality of transmission data pieces (the abnormal transmission data) to be the search result.

The control unit 3 of the in-vehicle device 2 determines whether to specify the transmission data having attackability on the basis of the execution result of the search formula with respect to the abnormality history database 42 (S115). In a case where the transmission data having attackability is specified (S115: YES), the control unit 3 of the in-vehicle device 2 registers the transmission data having attackability in the attack detection database 43 (S116). For example, when extracting the plurality of transmission data pieces corresponding to a case where the abnormality classification and the abnormality contents are the high transmission frequency (transfer frequency) and the rapid change in the signal, the control unit 3 of the in-vehicle device 2 specifies the transmission data as the transmission data having attackability, and registers the transmission data in the abnormality history database 42.

In a case where the transmission data having attackability is not specified (S115: NO), the control unit 3 of the in-vehicle device 2 performs the loop processing of executing again S111.

The control unit 3 of the in-vehicle device 2 executes the countermeasure on the basis of the information registered in the attack detection database 43 (S117). The control unit 3 of the in-vehicle device 2 executes the countermeasure for the transmission data having attackability on the basis of the information registered in the attack detection database 43.

The control unit 3 of the in-vehicle device 2, for example, selects the countermeasure according to the type of attack with reference to a look-up table stored in the storage unit 4. The countermeasure, for example, includes the replacement of the MAC generation key, the change in CAN-ID used, the change in the relay route using the redundant circuit, the transition to the fallback mode, and the like. The control unit 3 of the in-vehicle device 2 combines one or a plurality of countermeasures with reference to the look-up table in which the type of attack and the countermeasure are defined in association with each other to execute the countermeasure (counter processing) on the transmission data having attackability.

The control unit 3 of the in-vehicle device 2, as a part of the countermeasure, may notify (output) information such as the black list generated on the basis of the information registered in the attack detection database 43 to all the in-vehicle ECUs 6 mounted on the vehicle C by broadcast or multicast, regardless of the type of attack. The control unit 3 of the in-vehicle device 2 may register the information relevant to the countermeasure implemented in accordance with the transmission data having attackability in association with the transmission data in the attack detection database 43.

The control unit 3 of the in-vehicle device 2 outputs the information registered in the attack detection database 43 to the external server S1 (S118). The control unit 3 of the in-vehicle device 2 may transmit (output) the information such as the black list generated on the basis of the information registered in the attack detection database 43 to the external server S1 such as the SOC server S11 or the SIRT server S12.

In this embodiment, it has been described that the control unit 3 of the in-vehicle device 2 performs the set of processing pieces in parallel by the plurality of processes, but the present disclosure is not limited thereto, and from the data registration with respect to the chronological database 41 to the data registration and the output of the black list with respect to the attack detection database 43 may be performed by sequential processing.

The embodiment disclosed herein is illustrative in all respects and should not be considered restrictive. The scope of the present disclosure is indicated by the claims but not the meaning described above, and is intended to include all changes within the meaning and the scope equivalent to the claims.

1. An in-vehicle device to be connected to an in-vehicle Electronic Control Unit (“CECU”) mounted on a vehicle such that communication is available, the device comprising:
a control unit performing processing relevant to transmission data transmitted from the in-vehicle ECU,
wherein the control unit receives the transmission data transmitted from the in-vehicle ECU, registers the received transmission data in association with a reception time point of the transmission data in a chronological database, specifies abnormal transmission data from the transmission data registered in the chronological database, and registers information relevant to the specified abnormal transmission data in an abnormality history database.

2. The in-vehicle device according to claim 1, wherein the control unit determines whether the transmission data received from the in-vehicle ECU is normal,
registers the transmission data determined as normal in the chronological database, and registers the transmission data determined as abnormal in the abnormality history database.

3. The in-vehicle device according to claim 2, wherein when the transmission data received from the in-vehicle ECU is included in a normal data list set in advance, the control unit determines that the transmission data is normal.

4. The in-vehicle device according to claim 2, wherein when an error is detected in at least one of an authorization code, an inspection code, and a form included in the transmission data received from the in-vehicle ECU, the control unit determines that the transmission data is abnormal.

5. The in-vehicle device according to any one of claim 1, wherein the control unit extracts a plurality of transmission data by using a predetermined search formula for the chronological database, and specifies the abnormal transmission data on the basis of an extraction result of the plurality of transmission data.

6. The in-vehicle device according to claim 5, wherein the control unit cyclically performs extraction processing of the transmission data using a search formula for the chronological database, and a cycle of cyclically extraction processing is longer than a reception frequency of the transmission data transmitted from the in-vehicle ECU.

7. The in-vehicle device according to claim 5, wherein in a period including the reception time point of the transmission data, the search formula for the chronological database includes a search condition relevant to at least one of a transmission frequency in a plurality of associated transmission data and a change degree of contents included in a payload.

8. The in-vehicle device according to any one of claim 1, wherein the control unit generates report information on the basis of the information registered in the chronological database and the abnormality history database, and outputs the generated report information to an external server outside the vehicle.

9. The in-vehicle device according to any one of claim 1, wherein the control unit specifies transmission data having attackability among the abnormal transmission data registered in the abnormality history database, and registers information relevant to the specified transmission data having attackability in an attack detection database.

10. The in-vehicle device according to claim 9, wherein the control unit specifies the transmission data having attackability for the abnormality history database by using a search formula configured by combining a plurality of search conditions included in the search formula for the chronological database.

11. The in-vehicle device according to claim 9, wherein the control unit implements a countermeasure for the specified transmission data having attackability, and registers information relevant to the implemented countermeasure in association with the transmission data having attackability in the attack detection database.

12. The in-vehicle device according to any one of claim 9, wherein the control unit outputs the information registered in the attack detection database to the external server outside the vehicle.

13. A program for allowing a computer connected to an in-vehicle Electronic Control Unit (“ECU”) mounted on a vehicle such that communication is available to execute processing of:
receiving transmission data transmitted from the in-vehicle ECU;
registering the received transmission data in association with a reception time point of the transmission data in a chronological database;
specifying abnormal transmission data from the transmission data registered in the chronological database; and
registering information relevant to the specified abnormal transmission data in an abnormality history database.

14. An information processing method for allowing a computer connected to an in-vehicle Electronic Control Unit (“ECU”) mounted on a vehicle such that communication is available to execute processing of:
receiving transmission data transmitted from the in-vehicle ECU;
registering the received transmission data in association with a reception time point of the transmission data in a chronological database;
specifying abnormal transmission data from the transmission data registered in the chronological database; and
registering information relevant to the specified abnormal transmission data in an abnormality history database.
